(19) United States
(12) Patent Application Publication
(10) Pub. No.: US 2004/0117221 A1
(43) Pub. Date: Jun. 17, 2004

(54) Global timezone conversion for disparate corporate data

(75) Inventors: William B. Beglen, Kerhonkson, NY (US); Peter M. Derkowski, Staatsburg, NY (US); Jack K. Schmotzer, Alliance, OH (US)

Correspondence Address: IBM Corporation, M/S P386, 2455 South Road, Poughkeepsie, NY, 12601, US

(73) Assignee: International Business Machines Corporation, Armonk, NY

(21) Appl. No.: 10/317,535

(22) Filed: Dec. 12, 2002

(51) Int. Cl. G06F 17/60

(52) U.S. Cl. 705/7

(57) ABSTRACT

Method and apparatus providing global timezone conversion of date and time data from disparate corporate data wherein the conversion makes a global or corporate conversion of date and time data, and further makes program-specific conversion of date and time data for specific programs, as desired.

### FIELD OF THE INVENTION

The present invention is related to global timezone conversion for disparate corporate data, and more particularly to method and apparatus for describing and linking information about dates and time spanning disparate data sources, and further to methods and apparatus for adding product-specific methods of time storage to established data/time resolution.

### BACKGROUND OF THE INVENTION

Known solutions to providing standardized timezone conversion are manual, case by case resolution by customized methods that are parochial in nature.

U.S. Pat. No. 5,511,188 issued Apr. 23, 1996 to Pascucci et al. for NETWORKED FACILITIES MANAGEMENT SYSTEM WITH TIME STAMP COMPARISON FOR DATA BASE UPDATES discloses a system for maintaining global consistency among global variables in the nodes. At regular intervals, each node broadcasts its presence and a time stamp indicating the most recent update of its database of global variable. The node receiving the broadcast compares its timestamps with the one most recently broadcast.

U.S. Pat. No. 5,784,421 issued Jul. 21, 1998 to Dole et al. for COMPUTER PROGRAM PRODUCT FOR USE WITH A NETWORK NODE FOR PERFORMING ANONYMOUS TIME SYNCHRONIZATION IN A NETWORK, and discloses synchronization of a local time maintained at the node with a reference time facilitated through execution of prerecorded software by the node.

U.S. Pat. No. 6,282,709 issued Aug. 28, 2001 to Reha et al. for SOFTWARE UPDATE MANAGER discloses a computer-readable medium that includes stored sequences of instruction the are executed by a processor. The instruction causes the processor to download a file containing a list of software components form a remote server. The instruction also causes the processor to check a selected software component to determine whether the selected software component is the same version of software stored on the computer system.

U.S. Pat. No. 6,256,668 issued Jul. 3, 2001 to Slivka et al. for METHOD FOR IDENTIFYING AND OBTAINING COMPUTER SOFTWARE FROM A NETWORK COMPUTER USING A TAG and discloses a method wherein a tag comprises a description of the software upgrade including a time stamp indicating a date of the software upgrade.

Other background references include U.S. Pat. No. 5,136,647 issued Aug. 4, 1992 to Haber et al. which discloses a method for secure time-stamping of digital documents, U.S. Pat. No. 5,892,953 issued Apr. 6, 1999 to Bhagria et al. which discloses a corrective service facility, U.S. Pat. No. 6,006,270 issued Dec. 21, 1999 to Kobunaya which discloses a communication with time stamp controller for regulating data transmission rates, U.S. Pat. No. 6,233,238 issued May 15, 2001 to Romanowske et al. which discloses a method for updating clock references in a digital data stream and a remultiplexer, Japanese Patent No. JP7160763 published Jun. 23, 1995 to Yamada Yukio and others which discloses a work allocation method, and IBM Technical Disclosure Bulletin December 1991, pages 145-148 which discloses a process that allows increased ease of use and additional functionality when reporting on data from multiple locations in different timelines by specifying two timezone parameters for each location being reported upon.

### SUMMARY OF THE INVENTION

The present invention is a standardization of the linkage of disparate methods, providing a tool to bridge the gap between those methods and provide a centralized, easily customizable solution to a pervasive problem. This invention consists of the idea of describing and linking information about dates and times spanning disparate data sources. Using this method and the implementations, disparate corporate applications can accurately provide accurate time stamping, time measurements, and time reporting. It is a primary object of the present invention to provide a method to add corporate product-specific methods of time storage and resolution as an added feature to established date/time resolution. This allows for a global common solution for time resolution spanning zones, products, versions, and operating environments.

This invention provides a common method for ensuring that dates and times are displayed and reported (and potentially stored), using unique “corporate product aware” methods atop of the established global timezone rules. Libraries for timezone conversion, whether imbedded in an operating system or not, are not aware of corporate product date/time peculiarities and/or deviations from normal time interpretation.

It is a further object of the present invention to provide for local rules to be applied to timezone conversion, which local rules may be in addition to the corporate rules, or may exclude certain corporate rules, as may be desired.

It is a further object of the present invention to provide product specific rules to be applied to time date in specific products.

### BRIEF DESCRIPTION OF THE DRAWINGS

These and other objects will be apparent to one skilled in the art from the following detailed description of the invention taken in conjunction with the accompanying drawings in which:

FIG. 1 is a diagram showing a data processing system using the timezone conversion method of the present invention;

FIG. 2 is a flowchart showing the initialization of the timezone conversion program product of the present invention;

FIG. 3 is a flowchart showing the runtime processing of a program product which incorporates the present invention;

FIG. 4 is a flowchart showing the processing of the Mutator module of the program product of FIG. 3; and

FIG. 5 is a flowchart showing the time conversion module of the program product of FIG. 3.

### DESCRIPTION OF THE PREFERRED EMBODIMENT

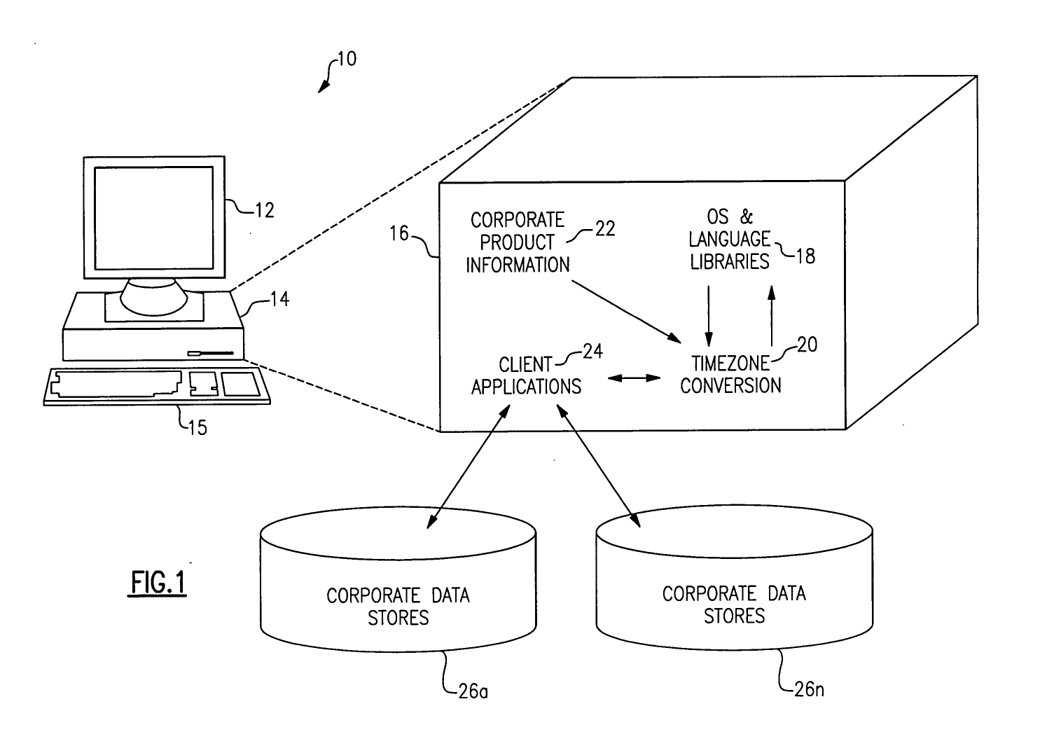

FIG. 1 is a diagram showing a data processing system 10 illustrated by a monitor 12, a processing unit 14 and a keyboard 15. While a personal computer system is illustrated at 10, it will be understood that any data processing system, including personal computers, work stations, and main frames may use the present invention. As is well known, the data processing system 10 includes a memory 16 in which an Operating System (OS) and operating libraries 18 which controls the processing of data in the data processing system 10. In the present invention, a timezone conversion program product or routine 20 is included which converts date and time data processed by the OS 18. When the timezone conversion routine 20 is established by the OS 18, its presence is flagged such that rules established by the conversion routine 20 will be applied to data and time data processed by the OS 18, to be discussed.

Other sources of date and time data are corporate product information 22 and client applications 24 which processes data for disparate corporate data stores 26a through 26n. As will be explained, the timezone conversion routine 20 includes corporate rules to be applied to operating system date and time date and corporate product information 22, and may include local rules to be applied to product specific applications using corporate data stores 26a-26n. It will be understood that the term corporate may mean a commercial enterprise, or may be understood to be a set of global rules to be applied to all data processed by the Operating System 18. The local rules may refer to rules to be applied in addition to global rules, or may be exclusions to the global rules, as desired. One advantage of the present invention is that the time conversion my be designed to convert date and time data to the time zone where the data processing system 10 is located, rather than where the corporate data stores 26a-26n are located, even if the data stores, or one of them, is located is another timezone.

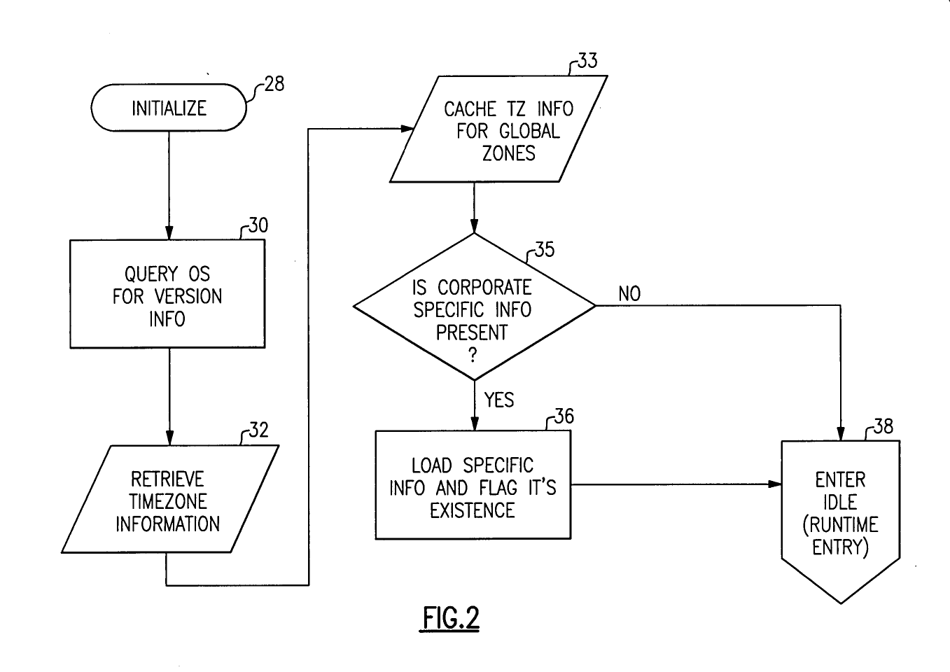

FIG. 2 is a flowchart showing the initialization of the timezone conversion routine 20 of FIG. 1. The initialization starts at 28. At 30, the Operating System 18 is queried for various information. It 32, the timezone information is retrieved. At 33, the timezone (TZ) information received at 30 and 32 is cached in the computer storage 16 to be used in the timezone conversion routine 20. A check is made at 35 to determine if the corporate specific information is present. If not, the computer system 10 enters the idle state and waits for a runtime entry. If the check at 35 is yes, at 36 the specific information is loaded into computer storage 16, and a flag is set to indicate that timezone conversion routine 20 is active and the information to make the corporate timezone conversion is present. The computer system 10 is then placed in the idle state at 38.

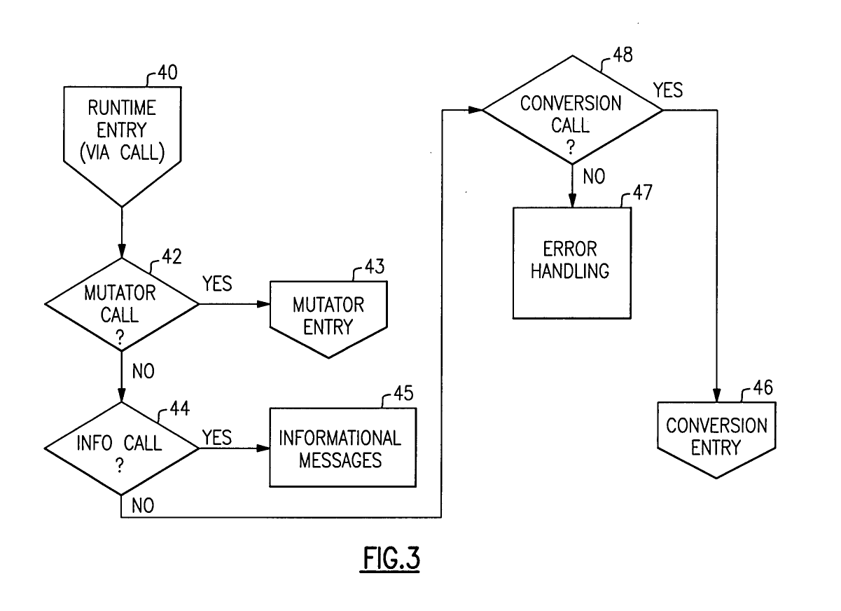

FIG. 3 is a flowchart showing how the present invention would be inserted into a reporting program which generates informational messages for instance in a report format. At 40, a runtime entry is made via a call. At 42, a check is made to see if a mutator call has been made. If yes, a mutator entry is made at 43, to be discussed. If the check at 40 is no, a check is made a 44 to see if an informational call has been made. If yes, at 45 informational messages are generated, as is well known. The informational message may be stored or printed or otherwise handled in a well known manner. If the check at 44 is no, a check is made at 48 to determine if a conversion has been called. If no, an error handling routine is entered at 45 report and handle the error. If the check at 44 is yes, a conversion entry is made at 46, as will be explained. It will be understood that the routine of FIG. 3 diagrams one possible use of the present invention for any exemplary operating system and an exemplary reporting system, and that other implementations may be used. The present invention is not to be limited to any particular operating system or reporting program.

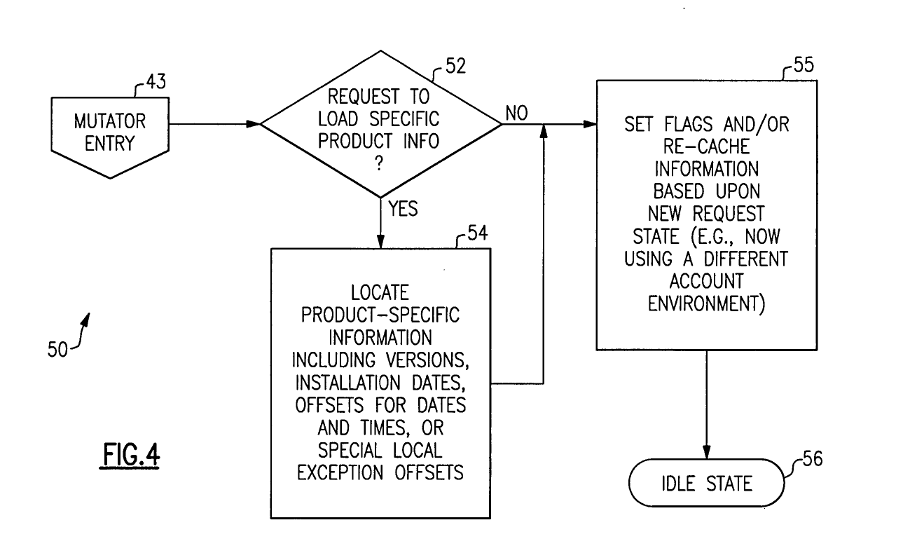

FIG. 4 is a flowchart of a mutator module 50 called at 43 of FIG. 3. The mutator module 50 is used to establish local rules to be applied to a specific product being run, for instance, by a client application 24. A check is made at 52 to determine if a request has been made to load specific product information. If yes, at 54 product-specific information is located which may, for instance, include versions, installation dates and times, and/or special exception offsets, to be used in the conversion of date and time data. If the answer at 52 is no or after 54, the routine at 55 sets flags and/or information based upon the new request state is re-cached such that the corporate rules, either as originally defined or as modified by the rules established at 54, is indicated. This may be done, for instance, by using a different account environment for the data conversion. The routine at 56 goes to the idle state.

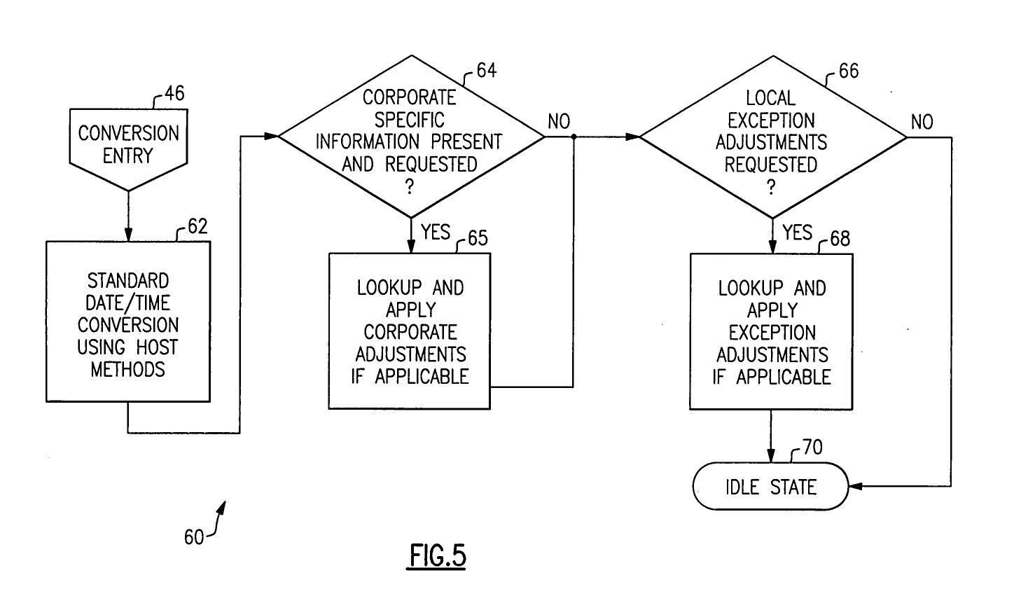

FIG. 5 is a flowchart showing a time conversion routine 60 called at conversion entry 46 of FIG. 3. At 62 the operating system 18 performs the standard date/time conversion of date and time date using the host methods. At 64, a check is made to determine if corporate specific information is present and requested. This is done, for instance, by checking the flag set at 36 of FIG. 2. If the answer is yes at 64, the conversion routine 60 does a lookup at 65 and applies the corporate adjustments from the specific information loaded at 36 of FIG. 2. As part of the adjustments, the converted date and time data is stored or printed, as is appropriate. After 65 or if the answer at 64 is no, the routine goes to the check at 66.

At 66, the conversion routine checks to determine if local exception adjustments are requested. This is done by checking the flag set at 55 of FIG. 4. If local exception adjustments are requested at 66, at 68 the routine 60 looks up and applies the exception adjustments re-cached at 55 of FIG. 4. Part of the application of the adjustments at 68 is to store and/or print out the adjusted date and time data, as appropriate. As mentioned, the exception adjustments may be additional modifications made to the date and time data, or may be excluding or omitting one or more corporate rules for this specific product, as may be desired. If the answer at 66 is no, or after 68, the conversion routine 60 returns to the idle state 70 to wait for the next runtime entry.

While the preferred embodiment of the invention has been illustrated and described herein, it is to be understood that the invention is not limited to the precise construction herein disclosed, and the right is reserved to all changes and modifications coming within the scope of the invention as defined in the appended claims.

What is claimed is:

1. A method for providing standardized time zone conversions in a data processing system to data of the data processing system, said method comprising:
establishing by an operating system, corporate rules to apply to time data located in data processed by said data processing system;
establishing product specific rules to be applied to time data located in data processed by a specific product;
setting flags observable by a client application, said flags indicating that said corporate rules and said product specific rules have been established;
upon processing data, querying said flags for locating established corporate rules to be applied to time data;
upon processing time data by a specific product, querying said flags for locating any local rules to be applied to time data processed by in said specific product; and
while processing data by said specific product, applying said established corporate rules and/or product specific rules to time data processed by said specific product.

2. The method of claim 1 wherein said time data includes date data.

3. The method of claim 1 wherein said time data includes timezone data indicating the timezone where the data is being processed.

4. The method of claim 1 wherein said product specific rules include local exclusions to said corporate rules.

5. The method of claim 1 further comprising storing the time data operated on by said corporate rules and/or said product specific rules with the data processed by said operating system.

6. A system for providing standardized time zone conversions to data processed by a data processing system, said system comprising:
memory in which is stored an operating system for operating the data processing system;
at least one data storage device for storing data to be processed by said data processing system, said data including time data;
corporate rules in said memory established by said operating system to apply to said time data;
product specific rules in said memory established by a client application, said product specific rules to be applied to time data processed by a specific product;
flags in said memory indicating that said corporate rules and said product specific rules have been established; and
a routine which, while processing data by said specific product, queries said flags and applies said established corporate rules and/or product specific rules to time data processed by said specific product.

7. The system of claim 6 wherein said time data includes date data.

8. The system of claim 6 wherein said time data includes timezone data indicating the timezone where the data is being processed.

9. The system of claim 6 wherein said product specific rules include local exclusions to said corporate rules.

10. The system of claim 6 wherein said routine stores the time data operated on by said corporate rules and/or said product specific rules with the data processed by said specific product.

11. A program product usable with a system providing standardized time zone conversions in a data processing system to data of the data processing system, said program product comprising:
a computer readable medium having recorded thereon computer readable program code performing the method comprising:
establishing by an operating system, corporate rules to apply to time data located in data processed by said data processing system;
establishing product specific rules to be applied to time data located in data processed by a specific product;
setting flags observable by a client application, said flags indicating that said corporate rules and said product specific rules have been established;
upon processing data, querying said flags for locating established corporate rules to be applied to time data;
upon processing time data by a specific product, querying said flags for locating any local rules to be applied to time data processed by in said specific product; and
while processing data by said specific product, applying said established corporate rules and/or product specific rules to time data processed by said specific product.

12. The program product of claim 11 wherein said time data includes date data.

13. The program product of claim 11 wherein said time data includes timezone data indicating the timezone where the data is being processed.

14. The program product of claim 11 wherein said product specific rules include local exclusions to said corporate rules.

15. The program product of claim 11 where said method further comprises storing the time data operated on by said corporate rules and/or said product specific rules with the data processed by said operating system.
